(19) United States
(12) Patent Application Publication
(10) Pub. No.: US 2003/0101184 A1
(43) Pub. Date: May 29, 2003

(54) Management system for parsing and receiving XML based schedules

(75) Inventors: Hung-Liang Chiu, Taipei (TW); Win-Chee Yu, Taipei (TW)

Correspondence Address: BACON & THOMAS, PLLC, 625 SLATERS LANE, FOURTH FLOOR, ALEXANDRIA, VA, 22314

(73) Assignee: INVENTEC CORPORATION, Taipei (TW)

(21) Appl. No.: 09/993,480

(22) Filed: Nov. 27, 2001

(51) Int. Cl. G06F 7/00

(52) U.S. Cl. 707/10

(57) ABSTRACT

A management system for parsing and receiving XML based schedules being established between a computer system of a product manufacturer and that of at least one original equipment manufacturer through the Internet so that the product manufacturer is capable of regularly receiving the XML based schedules from each original equipment manufacturer through the Internet for determining a correctness of the XML based schedules, parsing data therefrom, converting the data into EDI based schedules, and integrating the EDI based schedules with EDI based schedules stored in a database of the system.

### FIELD OF THE INVENTION

The present invention relates to management system and more particularly to a management system for parsing and receiving XML based schedules.

### BACKGROUND OF THE INVENTION

Conventionally, XML (extensible Markup Language) is developed based on SGML (Standard Generalized Markup Language). Hence, XML may be viewed as a part of SGML. XML is used to add markups in an e-mail based document for creating a structural e-mail based document. As a result, e-mail based documents are easy to be understood by computer and user. Further, e-mail based documents are easy to be used for communicating among users through the WWW (World Wide Web). In general, XML only defines syntax for adding markups without defining markups. But XML still allows user to define required markups in respective application field. As an end, a vocabulary containing a variety of XML is formed.

Typically, HTML is the most popular the Internet language among users. HTML is advantageous for its simple and practical characteristics. This makes it the widely used one on the Internet. But HTML is unsatisfactory for fulfilling the needs of the Internet for the following reasons:

1. The structure of HTML is not regular. Typically, markups are paired in HTML for enclosing word(s). However, some markups are not paired. Such irregularity results in many difficulties in use and in analyzing data. In one example, it is difficult to inquire database with respect to information contained in a Web page in an application software.

2. Definition of markup of HTML is fixed. This inherently limits the application of HTML. In fact, there are many specifically defined markups required in various application fields so as to clearly express specific structure and meaning of one e-mail based document in respective field.

3. Contents and presentation are mixed in HTML. This has a couple of drawbacks as detailed below. First, contents of a Web page is created for collecting and processing information while presentation of such contents belongs to the field of aesthetics which requires professional techniques. Hence, a mixed contents and presentation can cause difficulties in creating Web pages. Next, a mixed contents and presentation can cause respective Web pages of the same Web site to exhibit different presentations. In other words, there is an inconsistency among such Web pages.

For solving the above drawbacks, XML 1.0 rule is thus defined and in turn is proved and recommended by W3C on February 1998. In recent years, XML 1.0 rule has become the most important markup language on the Internet. Typically, XML based comprises element, attribute, and text as three basic components. Element means a pair of markups and contents (including pairs of markups and word(s)) enclosed therebetween. Attribute means contents enclosed by one pair of markups. Text means words enclosed by two pairs of markups. For correctly assembling elements of XML, it is required to comply with nested structure rule of XML syntax. Following is an example of correct XML document:

<name>

<family name>Wang</family name>

<first name>Shaw-ming</first name>

</name>

, where contents between <name> and </name>, <family name> and </family name>, or <first name> and </first name> is respective element of the XML document. Contents between each pair of markups such as name, family name, or first name is attribute. Text means words enclosed by two pairs of markups (i.e., beginning pair of markups and end pair of markups) such as Wang or Shaw-ming. It is found from the above that markups are required to appear in pair such as “<” and “>”. Also, the only difference between beginning pair and end pair of markups is that the latter has a “/” immediately followed the “<”. As defined by syntax of XML document, two elements are required to appear in pair for forming a nested structure except that there is no intersection therebetween.

Since the development of XML syntax, markup language can be standardized and applied to diversified, which enables the messages contained in XML document to communicate among platforms more easily. This in turn facilitates communication, searching and processing of mass information in various fields. Moreover, XML is simple to learn. For those skilled in the art of HTML, it is more easy to get started. As to existing HTML documents, it is possible of utilizing HTML syntax to solve problems associated with the conversion from HTML format to XML format. In brief, XML has played a very important role in the development of future network based information field.

Over the past decades, the pace of various occupations has been accelerated significantly due to fierce competition in the market. Quick and convenient communication and transportation also expand the range of commerce. For taking advantage of such trend, almost all well known product manufacturers and distributors thereof use the Internet as a tool of information exchange and communication among manufacturing department and overseas distributors. Next, it is possible of developing products tailored to the needs of local market prior to instructing worldwide manufacturers to produce the same. Finally, the products may be delivered to the consumers through associated distributors in the world. This process can significantly reduce cost and delivery time as well as enhance competition.

Conventionally, as shown in FIG. 1, a management system is established between a product manufacturer 10 and at least one original equipment manufacturer 20 in which the system utilizes a network connection 30 for establishing a communication channel between computer system of product manufacturer 10 and that of original equipment manufacturer 20. Hence, original equipment manufacturer 20 can perform the following: Regularly estimate quantity of products based on market in a forthcoming period of time. Regularly report the same to product manufacturer 10 through the channel in advance. Request product manufacturer 10 to estimate a possible quantity of products which can be supplied in that period of time based on inventory and a possible future production thereof as well as reply the same to original equipment manufacturer 20. Hence, original equipment manufacturer 20 can take the estimated quantity of supplied products as a basis for accepting orders from buyers. Also, product manufacturer 10 can reliably estimate a future production so as to adjust production as necessary. This can significantly reduce cost associated with inappropriate inventory (i.e., inventory is minimized).

Conventionally, in the management system, forecast schedules of original equipment manufacturer 20 in a format of EDI (Electronic Data Interchange) are sent to product manufacturer 10 through VAN (Value-Added Network) or the Internet. As to the transmission path, e-commerce solutions and path available from VAN provider (e.g., GEIS) are required to send EDI based schedules through such VAN based schedule transmission. This has the disadvantage of spending a lot of money on using communication line. While for the Internet based schedule transmission, the above lots of money spent on using communication line is not required by carrying out a mail based Web-EDI on the Internet. This further has the advantage of accessing data in a nearly real time basis. However, the schedules are still in form of EDI.

As stated above, due to the development of XML, relevant persons in the art try to apply XML based documents in the field of schedule transmission. However, it cause EDI based schedules stored in the management system to be incompatible with XML based schedules, resulting in a fail of communication and integration among data contained in schedules. Thus, it is desirable to provide an improved management system for parsing and receiving XML based schedules in order to overcome the above drawbacks of prior art.

### SUMMARY OF THE INVENTION

It is therefore an object of the present invention to provide a management system for parsing and receiving XML based schedules being established between a computer system of a product manufacturer and that of at least one original equipment manufacturer through the Internet so that the product manufacturer is capable of regularly receiving the XML based schedules from each original equipment manufacturer through the Internet for determining a correctness of the XML based schedules, parsing data therefrom, converting the data into EDI based schedules, and integrating the EDI based schedules with EDI based schedules stored in a database of the system. This thus has the advantages of saving lots of money on using communication line since there is no need to send schedules through the VAN and achieving the goal of accessing data in a nearly real time basis.

The above and other objects, features and advantages of the present invention will become apparent from the following detailed description taken with the accompanying drawings.

### BRIEF DESCRIPTION OF THE DRAWINGS

FIG. 1 schematically presents the connection of a product manufacturer and an original equipment manufacturer through the Internet according to the prior art;

FIG. 2 schematically presents the connection of a product manufacturer and an original equipment manufacturer through a network connection in a management system according to the invention; and

FIG. 3 is a flow chart illustrating operation of a preferred embodiment of management system according to the invention.

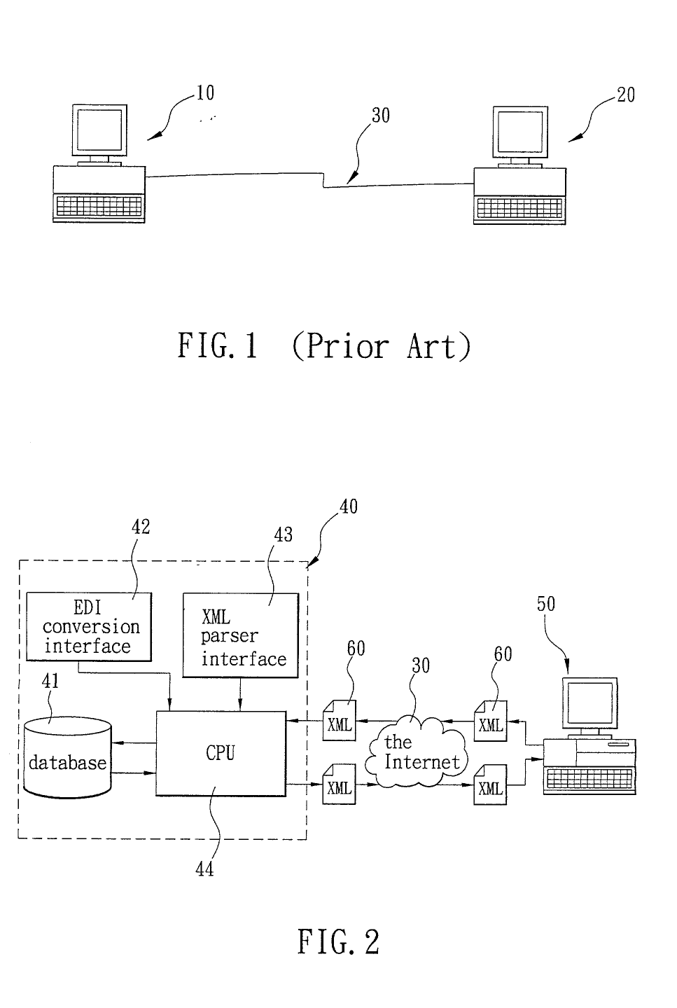

### DETAILED DESCRIPTION OF THE PREFERRED EMBODIMENTS

Referring to FIG. 2, a management system for parsing and receiving XML based schedules is established between a computer system of product manufacturer 40 and that of at least one original equipment manufacturer 50 through the Internet 30. Product manufacturer 40 can regularly receive XML based forecast schedules 60 from original equipment manufacturer 50 through the Internet 30. Further, the received XML based forecast schedules 60 are converted into EDI based forecast schedules. Next the management system integrates EDI based forecast schedules with the stored EDI based schedules in database 41. As such, it is possible of determining a possible quantity of products which can be supplied in a forthcoming period of time by means of analysis.

A preferred embodiment of management system, according to the invention as shown in FIG. 2, installs an XML parser interface 43 in computer of product manufacturer 40 for parsing XML based documents and an EDI conversion interface 42 for converting data into EDI based documents. XML parser interface 43 analyzes a correctness of each element of a received XML based forecast schedule 60 based on XML syntax and the nested structure rule. EDI conversion interface 42 converts parsed data in XML based schedule 60 into EDI based document.

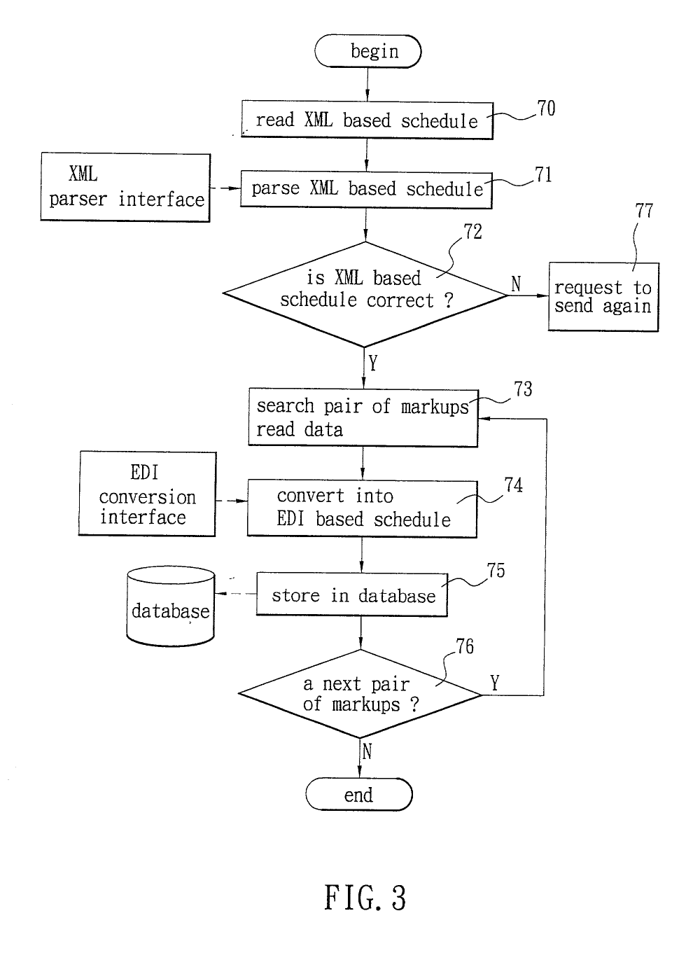

Referring to FIG. 3, a central processing unit (CPU) 44 in computer of product manufacturer 40 is commanded by management system to perform the following steps in response to the XML based forecast schedule 60 regularly being sent by original equipment manufacturer 50 and received by product manufacturer 40:

In step 70, read XML based forecast schedules 60 sent from computer of original equipment manufacturer 50.

In step 71, parse XML based forecast schedules 60 based on XML syntax and related nested structure rule contained in XML parser interface 43.

In step 72, analyze a XML based forecast schedule 60 for determining whether it complies with the XML syntax and the nested structure rule. If yes, process goes to step 73. Otherwise, process goes to 77.

In step 73, search a pair of markups of element in XML based forecast schedule 60 and read text and data enclosed by the pair of markups.

In step 74, convert the read text and data into an EDI based document based on relevant rule contained in EDI conversion interface 42.

In step 75, store EDI based document in database 41 for integrating with the stored EDI based documents therein.

In step 76, continue to search pair of markups of a next element in XML based forecast schedule 60 for determination. If a next element in XML based forecast schedule 60 is found, process goes back to step 73. Otherwise, process ends.

In step 77, an error message is displayed. Further, a packet is created for requesting computer of original equipment manufacturer 50 to send XML based forecast schedules 60 again.

In the embodiment, an XML based forecast schedule containing the following items is sent from original equipment manufacturer through the Internet:

(1) product quantity (e.g., 19);

(2) business identifier (e.g., 656066230);

(3) location identifier (e.g., 17);

(4) beginning date (e.g., Aug. 13, 2001); and

(5) end date (e.g., Aug. 20, 2001).

The forecast schedules may be in a form of XML based document as below:

−<ForecastSchedule>

−<ForecastCustomer>

−<ForecastQuantity>

−<ProductQuantity>19</ProductQuantity>

</ForecastQuantity>
−<UsedBy>

−<PartnerDescription>

−<BusinessDescription>

−<GlobalBusinessIdentifer>656066230 </
GlobalBusinessIdentifer>

</BusinessDescription>
−<PhysicalAddress>

−<GlobalLocationIdentifer>17</GlobalLocationIdentifer>

</PhysicalAddress>

</PartnerDescription>

</Used By>

</ForecastCustomer>
−<ForecastPeriod>

−<DatePeriod>

−<BeginDate>

−<DateStamp>20010813</DateStamp>

</BeginDate>
−<EndDate>

−<DateStamp>20010820</DateStamp>

</EndDate>

</DatePeriod>

</ForecastPeriod>

</ForecastSechedule>

In response to a receiving of XML based forecast schedule 60 in product manufacturer 40 from original equipment manufacturer 50, management system analyzes a correctness of each element of the received XML based forecast schedule 60 based on the syntax in XML parser interface 43 and the relevant nested structure rule and parses data enclosed between a pair of markups. EDI conversion interface 42 is commanded to convert parsed data into EDI based document which is in turn integrated with the stored EDI based schedules in database 41. The invention thus has the advantages of saving a lot of money on communication line use since there is no need to send schedules through the VAN and achieving the goal of accessing data in a nearly real time basis. While the invention has been described by means of specific embodiments, numerous modifications and variations could be made thereto by those skilled in the art without departing from the scope and spirit of the invention set forth in the claims.

What is claimed is:

1. A management system for parsing and receiving XML based schedules being established between a computer system of a product manufacturer and that of at least one original equipment manufacturer through the Internet so that the product manufacturer is capable of regularly receiving the XML based schedules from each original equipment manufacturer through the Internet, the system further comprising:
reading the received XML based schedules prior to converting into EDI based schedules; and
integrating the EDI based schedules with EDI based schedules stored in a database of the system.

2. The system of claim 1, wherein the system further comprises an XML parser interface for parsing XML based documents, analyzing a correctness of each element of the received XML based schedule based on an XML syntax and a nested structure rule, and parsing data from the XML based schedule.

3. The system of claim 2, wherein the system further comprises and an EDI conversion interface for converting data into an EDI based document, and converting the parsed data in the XML based schedule into the EDI based document.

4. The system of claim 3, wherein in response to the regular receiving of the XML based schedule in the product manufacturer from each original equipment manufacturer a central processing unit in a computer of the computer system of the product manufacturer is commanded by the management system to perform the steps of:
reading XML based forecast schedules sent from the computer of each original equipment manufacturer;
parsing the XML based forecast schedules based on an XML syntax and a related nested structure rule contained in the XML parser interface;
analyzing the XML based forecast schedule for determining whether it complies with the XML syntax and the nested structure rule;
searching a pair of markups of an element in the XML based forecast schedule and reading text and data enclosed by the pair of markups if a result of the analysis step is positive;
converting the read text and data into the EDI based document based on the rule contained in the EDI conversion interface; and
storing the EDI based document in the database for integrating with the stored EDI based documents therein.

5. The system of claim 4, further comprising displaying an error message and creating a packet for requesting the computer of the original equipment manufacturer to send the XML based forecast schedules again if the result of the analysis step is negative.
